(19) United States
(12) Patent Application Publication
(10) Pub. No.: US 2003/0142129 A1
(43) Pub. Date: Jul. 31, 2003

(54) Content processing and distribution systems and processes

(76) Inventors: Michael L. Kleven, Ocean Springs, MS (US); Christopher Ryan McClellen, Cumming, GA (US); James E. Patterson, Marietta, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/061,476

(22) Filed: Jan. 31, 2002

(51) Int. Cl. G09G 5/00

(52) U.S. Cl. 345/744; 345/721

(57) ABSTRACT

Systems and processes for accommodating one or more addressed or nonaddressed digital content signals (such as according to SDI or MPEG), real time, near real time or otherwise, from a satellite, terrestrial network or local storage; decoding the content signals; storing, process and otherwise handling the signals in order to produce altered content such as local weather or sports content; and distributing the altered content, with or without encoding, in digital and/or analog format as desired, for display or to remote units such as end-user set top boxes in a cable television system or computer equipment on an information infrastructure such as the World Wide Web. Storage, processing and other handling of the content from these various sources to create content for output and distribution can be performed under the control of a host, program functionality within the system, or as otherwise desired.

This invention relates to systems and processes for accommodating one or more digital content signals, real time, near real time or otherwise, from a host, network or local storage; decoding the content signals; storing, process and otherwise handling the signals in order to produce altered content such as local weather or sports content; and distributing the altered content, with or without encoding, for display or to remote units such as end-user set top boxes or computer equipment.

### BACKGROUND

Systems are known for distribution and display of localized content on cable television or other infrastructure. A series of such systems is adapted to distribute to various cable television systems throughout the United States and other geographical areas weather information which is tailored for the geographical location of the cable system. Briefly, such localized weather content distribution systems receive as input one or more streams, channels or sources of data from weather data providers, process that data and address it for delivery to specific receiver/processor units each of which is located at a cable head end and each of which may have a specific hierarchical or nonhierarchical address, and then feed the processed and addressed data to a communications infrastructure such as a conventional satellite transponder distribution system. (In this document, the term “content signal” means data, information, content or programming being received by systems and processes according to the present invention in whatever format, digital or analog, streaming or otherwise, real time, near real time or from memory or other source.) The receiver/processor units are adapted to receive, process and store information addressed to them, and then display the information as television programming on command from a central location, according to a schedule, on command from the cable television operator or the cable subscriber, or as otherwise desired. Such systems are disclosed in U.S. Pat. No. 4,725,886 issued Feb. 16, 1988 entitled, “Communications System Having an Addressable Receiver”; U.S. Pat. No. 4,916,539 issued Apr. 10, 1990 entitled, “Communications System Having Receivers Which Can Be Addressed in Selected Classes”; and U.S. Pat. No. 5,140,419 issued Aug. 18, 1992 entitled, “Communications System”; all of which are incorporated herein by this reference.

These conventional localized content distribution systems have typically transported the localized content, as well as other services and command information, in the vertical blanking interval of the standard National Television System Committee (“NTSC”) or Phase Alternate Line (“PAL”) analog television signal, or on a subcarrier of the analog signal carrier. (All standards and specifications referred to in this document are incorporated by this reference.) The receiver processor unit is adapted to demodulate the transponder signal, extract the localized content and store, process and render it as desired at desired times on the cable system, and pass through the video signal with accompanying audio. Accordingly, systems such as The Weather Channel are able to provide a national video (such as NTSC) feed of nationally-relevant weather information including on camera personalities, weather maps, and national advertising, and, in addition, at preselected times, break for display of the received custom-tailored and addressed, stored and locally-computer generated content such as local conditions and forecasts in the form of graphics and audio which has been converted into NTSC format for distribution on the cable system.

Such conventional localized content distribution systems have been useful for distributing and rendering localized content in the form of computer generated graphics, using character generator display techniques, and later, conventional bitmapped graphics which can be received, stored and generated/displayed on command from a central source such as The Weather Channel's operation in Atlanta. Still later, it has been possible to receive, store and generate/display limited motion video graphics such as successive frames of computer generated Doppler radar maps to show how storm systems are tracking, for example. Such techniques are also useful for some forms of advertising.

Recent advances in digital compression technology create the opportunity to distribute, store and render, whether stored or in real time, more sophisticated forms of localized content, such as video programming and more sophisticated forms of graphics and advertising. (For purposes of this document, “content” means any information, television programming, moving or still graphic images, sounds, stereographic or monaural audio recordings, movie clips, data file or dataframe, signal, data unit or sequence, substantive content, electromagnetic, electrical or magnetic or coherent or noncoherent light manifestation or instantiation, whether analog or digital, which corresponds ultimately to anything that can be sensed by a living organism.) For example, digital television standards are being adopted and implemented to allow cable operators to receive and process digital content from a variety of content vendors. An example, used herein in a nonlimiting way, is ATSC-ASI, Advanced Television Standards Committee (ATSC) Asychronous Serial Interface (ASI), which is incorporated herein by this reference. That interface is widely adopted in the United States. The Digital Video Broadcast (DVB) Asynchronous Serial Interface (ASI) is another alternative. The DVB-ASI standard, which is incorporated herein by this reference, and satellite transponders and associated network transport infrastructure which are DVB-ASI compliant, are being adopted and implemented by the worldwide cable TV industry, primarily in Europe, as an open network standard; enabling cable operators to benefit from multiple vendors supplying digital headend products that are DVB-ASI compliant.

At the same time, digital video encoding, compression and transport standards defined by the Moving Pictures Expert Group (“MPEG”), and more particularly the MPEG-2 standard, which is incorporated herein by this reference, provides compression support for television quality distribution of digital video, by allowing the digital video signal to be compressed to a manageable bit rate. For example, an uncompressed PAL television picture requires 216 Mbps, far beyond the capacity of most radio frequency links. NTSC provides less precise color information, and a different frame rate, but an uncompressed NTSC signal still requires 168 Mbps of bandwidth. The situation becomes much more acute, when one realizes that high definition television can require raw bandwidth exceeding 1 Gbps (1000 Mbps). MPEG2 carrying broadcast quality NTSC video, by contrast, requires only 2-3 Mbps. MPEG-2 Transport supporting ATSC or DVB satellite multiplexed feed requires only 27-40 Mbps, and offers services in addition to the video content signal.

The MPEG-2 and other digital standards also offer additional functionality that is particularly useful for, among other things, interactive television and interactive television in combination with localized content such as weather content. For example, a supplier such as The Weather Channel could offer subscribers who have appropriate functionality the opportunity to interact with The Weather Channel in a cable television operation, whether as part of the television distribution infrastructure or internet sessions or a hybrid of both, in order to tailor their own content. A subscriber could use a remote control, for example, and request local weather conditions and specific weather maps for whatever desired location, at whatever desired time, either using an MPEG-2 or other digital “television” interface, an “internet” interface carried on the television infrastructure as part of the MPEG-2 functionality or separate transport, or a hybrid of both such as infrastructure that employs MPEG-2 standards in combination with Asychronous Mode Transfer (“ATM”) and/or Internet Protocol (“IP”) standards and protocols. All of these standards and protocols are incorporated herein by this reference. It goes without saying that systems and processes according to the present invention are compatible with whatever desired digital technology, currently existing or adopted in the future, for every layer of content production, storage, transport, networking, management, distribution, rendering, and rights management.

MPEG-2 and other digital standards offer at least the following which may be useful for localized content distribution systems:

Video compression

Full-screen interlaced and/or progressive video (for television and computer displays)

Enhanced audio coding (high quality, mono, stereo, and other audio features)

Transport multiplexing (combining different digital content signals in a single transmission content signal)

Other services (GUI, interaction, encryption, and data transmission, for example)

Interactivity supported by MPEG-2 or other digital standards on localized content distribution systems can include diverse services such as:

Display and control of small video clips to show weather or other related video or graphics, or to promote products/future programming

Ability to select and pay for Video on Demand (VoD)

Access to remote information servers

Access to remote databases/systems providing home shopping, banking, other transactional activities.

Internet Access

This convergence to a set of standards which can accommodate localized digital content distribution systems at affordable prices for cable operators and other television programming-related entities provides the set of conditions needed for systems and processes according to the present invention.

### SUMMARY

Systems and processes according to the present invention are adapted to distribute to various cable television systems or receiver/processor units, and to various subscribers whether interactively or not, in various geographical areas, or as otherwise desired using appropriate designation or addressing, content which is tailored for particular circumstances such as, for example, local weather content corresponding to the geographical location of a cable system, units or subscribers, or sports information relating to performance of teams in a particular area.

As one example, content distribution systems according to the present invention can receive as input one or more content signals of data from weather data providers, process that data and address it for delivery to specific receiver/processor units or subscriber whether triggered centrally or on request from a subscriber. Alternatively, apart from an addressing paradigm, such content can be disseminated to a population of receiver processor units, each of which can select, store and process components of the incoming data autonomously or quasi autonomously according to a microprogram or other control application the receiver/processor has previously received or accessed.

In any event, the receiver/processor units and/or subscriber units are adapted to receive, process and store information addressed to them, and then display the information as televison or video programming or content on command from a central location, according to a schedule, on command from a stored microprogram, the cable television operator or the cable subscriber, or as otherwise desired. As mentioned above, a variety of information and services can be supported, including interactive services and content.

Systems and processes employ functionality which is adapted to decode digital data content signals, store and process those content signals in order to create customized or localized content or programming, and then encode that programming or content for distribution. While in some respects it may seem as a general matter counterintuitive to decode digital data only to reencode it later, systems and processes according to the present invention have been found to be efficient and effective in accommodating one content signal or multiple content signals from multiple sources, selecting, storing and processing components from those content signals, and creating content from them which can then be encoded and distributed on cable systems or other networks.

### BRIEF DESCRIPTION

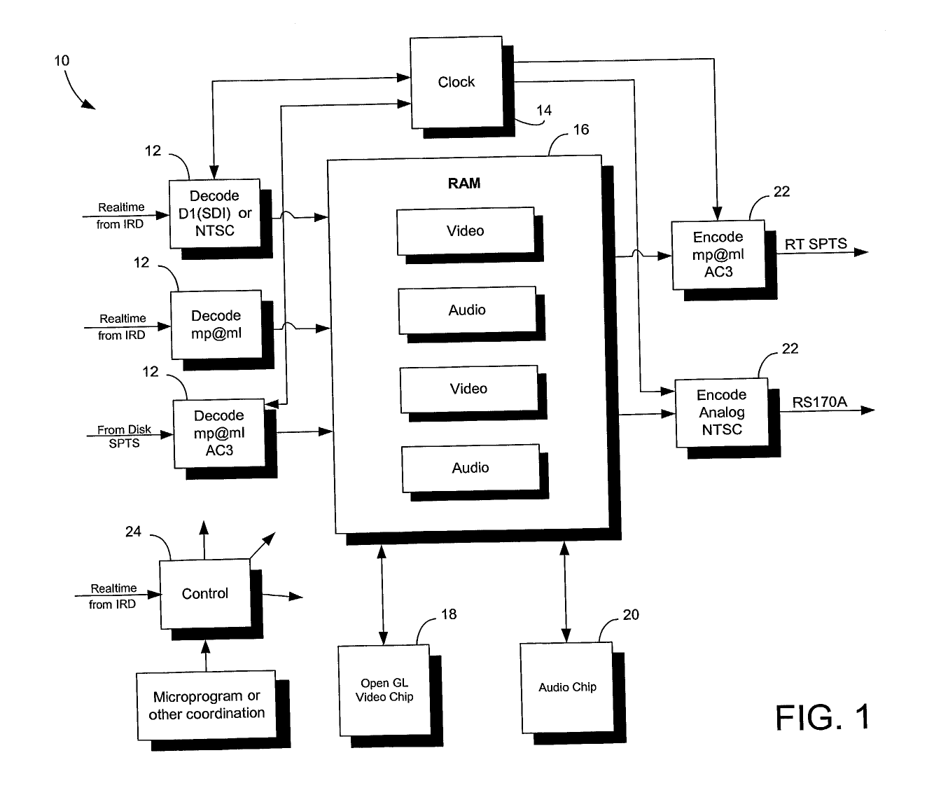

FIG. 1 is a schematic functional block diagram of a preferred embodiment of systems according to the present invention which can be used to carry out processes according to the present invention.

### DETAILED DESCRIPTION

Systems and processes according to the present invention, whether at the headend level or the subscriber level or both, which units may be thought of in some senses as clients in a client/server architecture, may be responsible for all decode, manipulation, and encode functions or operations on such content, including audio and video. Standard transport technology such as ATSC or DVB-ASI can be used to transport digital content using, for example SDI, NTSC or MPEG standards. Such systems and processes can be implemented on a card or cards(s) that can be installed in the Advanced Graphics Port (“AGP”) and/or Peripheral Component Interconnect (“PCI”) slot(s) of a unit implemented in a computer running the Linux or other desired operating system on an Intel or other desired processor. Systems and processes according to the present invention can interact and be used with functionality such as standard ATSC or DVB-ASI receive and, if desired, transmit functionality, for connectivity to sources of content in the architecture via satellite transponder, terrestrially, via physical medium such as fiber, coaxial cable or wireline, combinations thereof, or as otherwise desired.

Systems and processes according to the present invention can include functionality for:

Video decoding.

Audio decoding.

Video composition.

Audio mixing.

Video encoding.

Audio encoding.

FIG. 1 is a functional block diagram that schematically renders a preferred embodiment of systems and processes according to the present invention, in a non-limiting way. FIG. 1 shows merely one particular implementation, and is intended merely as an example for discussing the digital content decoding, composition, mixing, storage, encoding, and other functions which may be carried out to support systems for localized content distribution such as local weather information that can be triggered on command from a remote location, requested interactively by a subscriber, or otherwise.

FIG. 1 shows three sources of information, data or content which can be handled by systems 10 according to the present invention as received from satellite, terrestial or other distribution systems, or from local or network storage devices. More or fewer sources of analog or digital information, data or content can be handled by systems and processes according to the present invention. FIG. 1 shows an embodiment that is adapted to handle (1) a D1 (SDI) content signal from such as received from satellite and processed real or near real time in an integrated receiver decoder (IRD); (2) an MPEG-2 content signal as received rom satellite and processed real time or near real time in an IRD; and (3) an MPEG-2 content signal from local storage. Decoders 12 may be conventional or as otherwise desired to properly decode whatever content signals are being handled by system 10, and produce digital or analog output for subsequent handling by the system. Other configurations are possible and may be of use, including: (1) acceptance and generation of composite analog video and balanced audio or other analog content in combination with digital content; (2) omission of certain functionality as desired; for example, modularity such as use with an offboard encoder or decoder.

Some characteristics of the decoders can include:

At least content signal can be delivered in real time.

Other content signals need not be active at all times.

Other content signals may arrive in real time, or may be spooled from disk or other mass memory device, locally or remote.

The clock can be recovered from a real time content signal (referred to as the primary content signal).

A content signal from disk (if any) must preferably be decoded at a frame rate matching the primary content signal.

If both content signals are real time, they can be created from the same reference clock.

It is preferable to switch which content signal is the primary without shutting down the decoders or encoders.

The decoders are preferably able to support a video content signal of at least 15 mbps.

The decoders are preferably able to support an audio content signal of at least 640 kbps.

The controlling host is preferably notified when a decoded frame is available.

VBI lines are preferably be decoded and associated with the video frame.

The frame rate of the primary content signal is preferably 29.97 fps.

The audio sample rate is preferably 48 khz.

The video frames size is preferably 720×480.

Because systems and processes according to the present invention preferably involve tandem compression, a 4:2:2 content signal may be needed.

A clock 14 can coordinate timing of operations such as decoding and encoding according to the present invention, so that output can be, for instance synchronized real time or near real time with input digital content signals, is preferably is preferably synced with the incoming Programming Clock Reference (“PCR”).

RAM 16 provides video and audio digital content file and data storage and workspace in the system shown in FIG. 1. RAM 16 can be configurable in whatever manner including dynamically to accommodate video and if desired audio content, located locally or remotely on a network or otherwise, sized as appropriate, and otherwise implemented in conventional or unconventional manner to store and allow workspace for digital video and if desired audio content input from decoders 12, transacted with graphics functionality such as video processor 18, audio processor 20 if desired, and output to decoders 22. It, as well as other components of the system shown in FIG. 1, may be under control of control functionality 24.

Content which can be stored in RAM in the embodiment shown in FIG. 1 includes:

Decoded video frames.

Decoded audio frames.

OpenGL or other graphics standards-compliant textures.

Audio clips.

Open GL or other graphics standards lists.

Finished video frames.

Finished audio frames.

RAM is preferably sufficient to support a minimum of 30 frames of video and audio with sufficient video textures and audio clips.

The video processor 18 shown in the system of FIG. 1 is preferably a conventional OpenGL Linux/XFree864.0xGLX or DRI supported hardware accelerated graphics processor. The components that can be used to create the finished video frame include:

Video frames from the primary decoder.

Video frames from non-primary decoders.

Graphic content transferred from the host.

Textures transferred from the host or from other sources.

Operation in YUV color space or in RGB with component sizes >8 bits.

Preferably able to perform 1000 texture operations equating to 10 full screen coverages for every 1/30^{th} of a second. This does not mean that 10 full screens worth of unique data is associated with every frame, since much of the data can be reused across frames.

The audio processor 20 shown in FIG. 1 is preferably capable of mixing at least 3 content signals with volume control on each content signal. The content signals that can mixed include:

The content signal from the primary decoder.

Content signals from non-primary decoders.

Clips from the host (may be pre transferred from the host if needed).

Preferably able to mix a minimum of at least three content signals in real time.

If configured for MPEG-2 output, the system shown in FIG. 1 is preferably able to accept finished audio and video frames from the RAM 16, which have been assembled in accordance with instructions from a control functionality such as control functionality 24, and encode them using one or more encoders 22 into MP@ML video and stereo AC-3 at configurable bit rates.

Encoders 22 can be conventionally implemented or as otherwise desired. Some characteristics of encoders 22 shown in FIG. 1 can currently include:

SPTS is preferably constant bit rate (“CBR”)

SPTS preferably contains valid system information (“SI”)

Bit rates for video is preferably configurable between 2.5 and 8 mbps.

Bit rates for audio is preferably configurable between 32 and 640 kbps.

The SPTS is preferably generated in real time.

The SPTS preferably contains a valid program clock reference (“PCR”) that is synced to the clock from the decoder.

Controlling host is preferably able to notify encoder when frames are finished.

Finished frames can preferably be queued up for encode (finished at faster or slower than real time).

The VBI data associated with a finished frame is preferably encoded.

The frame rate is preferably 29.97 fps and can be synced to the primary decoder.

The video frames size are preferably 720×480.

Audio is preferably 48 khz stereo.

The MPEG-2 encoder is preferably able to be turned off or depopulated for deployment in analog headends.

If configured for NTSC output, the system shown in FIG. 1 is preferably able to accept finished audio and video frames from the RAM 16 and encode them using encoders 22 of a type which may be different from MPEG encoders 22 mentioned above into composite NTSC and balanced audio.

Some characteristics of the NTSC encoders can include:

Video quality at a minimum should be equivalent to subjective Beta SP.

Signal should be compliant with SMPTE 170M-1999 and EIA RS 250-B and NTC-7 standards where applicable.

The signal should be generated using the clock from the decoder 22 as a reference.

Controlling host should be able to notify encoder 22 when frames are finished.

Finished frames should be able to be queued up for encode (finished at faster or slower than real time).

The VBI data associated with a finished frame should be encoded.

The frame rate should be 29.97 fps and could be synced to the primary decoder.

The video frames size should be 720×480.

Audio can be configurable to support stereo or mono or both.

Control functionality 24 is coupled as desired to various components of system 10 as desired, in order to do any or all of the following: control production of content in the form of video frames and audio for digital and/or analog output to the distribution system, coordination of decoders and the timing and nature of their output of source content; configuration, operation and storage of source content, new content, audio content and other information or content in RAM 16; timing and operation of video processor 18 in cooperation with RAM 16 and the source and new content that is being handled and created; coordination of encoders and the timing and nature of their output of new content to the distribution system, and use of the clock to control synchronization and/or timing or system 10 or any portion thereof. Control functionality 24 may be implemented in the form of any suitable processing and support circuitry including appropriate memory and input/output circuitry. It may be located integral to other circuitry in system 10, or remote such as on another circuit board, computer or network. It may receive instructions real time or near real time from a host, be under control or partial control of a locally stored program, or receive control or instruction information from any source as desired in order to control and coordinate production of new content.

What is claimed is:

1. A system for creating new content from a plurality of sources of source content, comprising:
a first decoder which is adapted to receive (from host) and decode at least one (addressed, nonaddressed) digital source content signal as a primary signal,
at least one second decoder which is adapted to receive (from host or local source) and decode at least one other source content signal (digital or analog) as a secondary signal,
storage circuitry adapted to store at least decoded source (also video frames) content from said decoders;
graphics processing circuitry (coupled to said storage circuitry) adapted to produce new content (video frames, content customized to geographical area, content customized to consumer preferences) using said source content (audio processing circuitry);
at least one first encoder adapted to encode at least some of said new content into digital format for output to a distribution system;
at least one second encoder adapted to encode at least some of said new content for (digital, analog, both) output to said distribution system;
a clock adapted to control timing of at least one decoder and one encoder; and
control functionality adapted to control production of said new content for output to said distribution system, as directed at least in part by control signals received from said host (from locally stored program, microprogram).

2. A system according to claim 1 in which the control functionality also receives control signals from a stored program.

3. A system according to claim 2 in which the stored program is a locally stored microprogram.

4. A system according to claim 1 in which the control functionality is adapted to control production of new content that corresponds to a geographic area.

5. A system according to claim 1 in which the control functionality is adapted to control production of new content that corresponds at least in part to a member selected from the following set relating to a plurality of individuals: characteristics, preferences and interests.

6. A system according to claim 1 in which the control functionality is adapted to control production of new content that corresponds at least in part to one or more markets.

7. A sys tem according to claim 1 in which at least some of the source content is addressed.

8. A system according to claim 1 in which at least some of the source content is non-addressed.

9. A system according to claim 1 in which a second decoder is adapted to receive source content from said host.

10. A system according to claim 1 in which a second decoder is adapted to receive source content from a local source.

11. A system according to claim 1 in which at least one of said decoders is adapted to accommodate analog video signals, and at least one of said encoders is adapted to produce analog video signals.

12. A process for creating new content from source content, comprising:
receiving a first digital content signal from a host;
receiving a second content signal from a non-host source;
decoding said first and said second content signals;
transforming components of said first content signal and said second content signal into video content;
according to control signals which at least partially emanate from said host, and at least partially from a non-host stored control program, processing and organizing said video content to form said new content; and
encoding said new content for distribution on a distribution infrastructure; whereby
a plurality of systems carrying out said process are adapted to display national programming and programming based on new content adapted for a subset of users of said national programming, at least partially under control of said host.

13. A process according to claim 12 further comprising identifying and using only source content and control signals having predetermined addressing.

14. A process according to claim 12 in which the operating mode of processing and organizing said video content is governed at least partially by a locally stored program received from said host.

15. A process according to claim 12 in which said new content corresponds at least in part to a geographic area.

16. A process according to claim 12 in which said new content corresponds at least in part to a member selected from the following set relating to a plurality of individuals: characteristics, preferences and interests.

17. A process according to claim 12 in which said new content corresponds at least in part to one or more markets.

18. A process according to claim 12 wherein said control of said host is real time control.

19. A process according to claim 12 in which at least some of said encoding and said decoding happens in real time as governed by a common clock.

20. A process for creating new content from source content, comprising:
receiving a first digital content signal from a host;
receiving a second content signal from a non-host source;
decoding said first and said second content signals;
transforming components of said first content signal and said second content signal into video content;
according to control signals which at least partially emanate from said host, and at least partially from a non-host stored control program, processing and organizing said video content to form said new content; and
encoding said new content for distribution on a cable television system; whereby
a plurality of systems carrying out said process are adapted to display national programming and programming based on new content adapted at least in part to correspond to local weather conditions for users of said national programming in the geographical area of said cable television system, at least partially under control of said host.
